(19) United States
(12) Patent Application Publication
(10) Pub. No.: US 2012/0157275 A1
(43) Pub. Date: Jun. 21, 2012

(54) METHOD AND SYSTEM FOR DETECTING WEAR IN IMAGING DEVICES

(75) Inventors: ANTHONY PETERS, Hertfordshire (GB); LEE MONAHAN, Hertfordshire (GB); STEVE ABBOTT, Welwyn Garden City (GB); MARK GEARING, Bedfordshire (GB); LEE O'BRIEN, Welwyn Garden City (GB)

(73) Assignee: XEROX CORPORATION, NORWALK, CT (US)

(21) Appl. No.: 12/972,239

(22) Filed: Dec. 17, 2010

(51) Int. Cl. B65H 5/06; B32B 3/26

(52) U.S. Cl. 492/9; 428/321.5; 428/314.4

(57) ABSTRACT

Methods and system for detecting wear in imaging devices. The system includes an outer wearable layer. An inner layer fused to the outer layer. The inner layer is made of multiple microcapsules including odiferous oils. Wearing off of the outer layer, over time, exposes the inner layer. Subsequently, with added pressure on the inner layer, the microcapsules crack, giving off a particular scent. By detecting the smell, customers can identify worn components of the imaging devices.

### TECHNICAL FIELD

The presently disclosed embodiments relate to imaging devices, and more particularly to methods and systems for detecting wear in imaging devices.

### BACKGROUND

Most imaging devices, such as printers, scanners, and copiers, include extensive internal machinery that facilitates image processing. For example, printers have multiple print rollers, feeder rollers, flexible belts, and baffles that handle media frequently. These machine parts, over time, may wear, affecting printing efficiency. Typically, consumers may not be aware of the extent of roller wear until the imaging device malfunctions. For example, rollers or baffles may be worn to such an extent that they begin to jam media within the imaging device.

When such a malfunction occurs, consumers typically contact customer service representatives. In addition, as consumers are generally not aware of the exact problem, they merely inform the representative that a fault has occurred and that the imaging device is not functioning properly. The customer service representative then must speculate the reason for malfunction based on a number of factors such as device age, usage frequency, part of the device where media is jammed, and other such details. Often, it is difficult for the representative to be certain of the defect even with all this device information handy.

Thus, when a technician visits the consumer's premises to fix the problem, he may not be well prepared to repair the imaging device on the spot. If the representative has not correctly diagnosed the problem, the service engineer may take a wrong spare part to the customer's premises, increasing downtime.

In large organizations, printer malfunctions can disrupt daily business, leaving organizations crippled. In these places of business, it is important to minimize device downtime as much as possible, predict upcoming system failure, and fix upcoming issues before they cause downtime. A simple and cost-effective system for detecting and confirming system wear is desired.

### SUMMARY

One embodiment of the present disclosure provides a system for detecting wear of a component of an image forming device. The system includes a wearable component. The wearable component further includes an outer surface layer made of a wearable material. The component further includes an inner layer composed of multiple microcapsules filled with odiferous oil. The microcapsules are exposed due to continued use of the component. On exertion of a force, these microcapsules crack, releasing a scent indicating that the component is worn.

### BRIEF DESCRIPTION OF THE DRAWINGS

FIG. 1 illustrates an exemplary system according to embodiments of the present invention.

FIG. 2 illustrates an exemplary microcapsule layer according to embodiments of the present invention.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

Overview

The present disclosure describes embodiments of a system that detects wear or failures in image scanning devices. Recent advances in polymer materials have enabled scientists to create polymers that emit a scent when the material's structure is damaged in any way. For example, small cracks in the polymer might emit a light scent, while a deep gash might emit a strong smell. This scent is produced by odoriferous oils enclosed in microcapsules within the polymer material. When a microcapsule cracks, it releases the odiferous oil producing the scent. The more the wear, the more microcapsules crack, and the higher the intensity of the scent.

Embodiments of the present invention utilize a layer of this microcapsule material under the conventional roller layer in feeder rollers, printer rollers, and the like. The existing roller layer may form the outer layer, while the polymer material forms the inner layer. As the outer layer wears off, the microcapsules layer is revealed. Any further wear then begins to crack the capsules, releasing a particular smell. If a user is aware of the significance of the smell, she can easily identify the worn device part that may require immediate attention.

Adding the microcapsule polymer material to the wearable components of an imaging device enhances the efficiency of the existing service strategy and service activities. For example, customer service representatives can confirm the exact malfunctioning part, for a given customer complaint, such as media miss-feed, by asking the customer whether the imaging device is giving off any particular scent. If the answer to that question is affirmative, the representative can safely confirm the root cause of the malfunctioning.

Exemplary Embodiments

Feed rollers, along with other type of rollers are utilized in most imaging devices to feed paper in the correct alignment and orientation to the printing or scanning apparatus. The feed roller typically includes a metal shaft covered by a layer of rubber, plastic, or foam such as closed-cell foam.

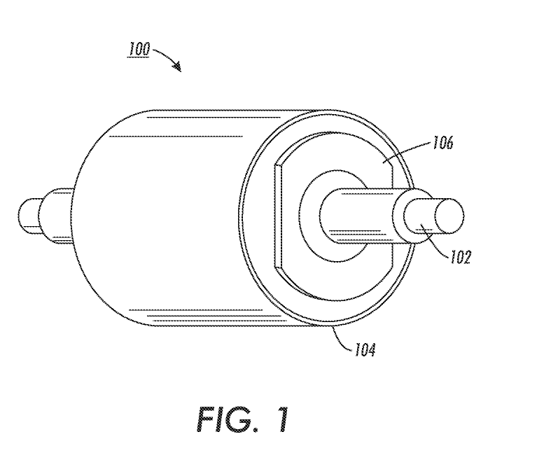

FIG. 1 illustrates one such feed roller 100 where embodiments of the present invention may be incorporated.

It will be understood that embodiments of the present invention may be utilized in feed rollers of varying shape and size without departing from the scope of the present invention. Moreover, embodiments of the present invention may be utilized in one or more feed rollers, fuser rollers, or printer rollers of an imaging device without departing from the scope of the present invention.

The feed roller 100 includes a shaft 102 covered by an outer layer (component layer) 104. This layer 104 may be made of any suitable material such as closed cell foam, elastomer, rubber, or plastic. In addition to the outer layer 104, the feed roller 100 includes a second layer (also referred to as “inner layer”, “microcapsule layer”, or “scent layer”) 106 between the outer layer 104 and the metal shaft 102. This inner layer 106 is made of microcapsules containing odiferous oils, as described in more detail below.

The outer layer 104 material is typically such that it wears over time. The more media the feed roller 100 handles, the faster is wears. When the outer layer 104 begins to wear out, it exposes the inner layer 106. Subsequently, the inner layer 106 may start to wear, resulting in cracks in the microcapsules that give off a particular scent. Wearing of the outer layer 104 causes multiple malfunctions in an imaging device, such as misfeeds, paper jams, feeding multiple media sheets at once, etc. With the inclusion of the odiferous oil containing inner layer 106, the feed roller 100 wear can be brought to the notice of the customer before the imaging device fails.

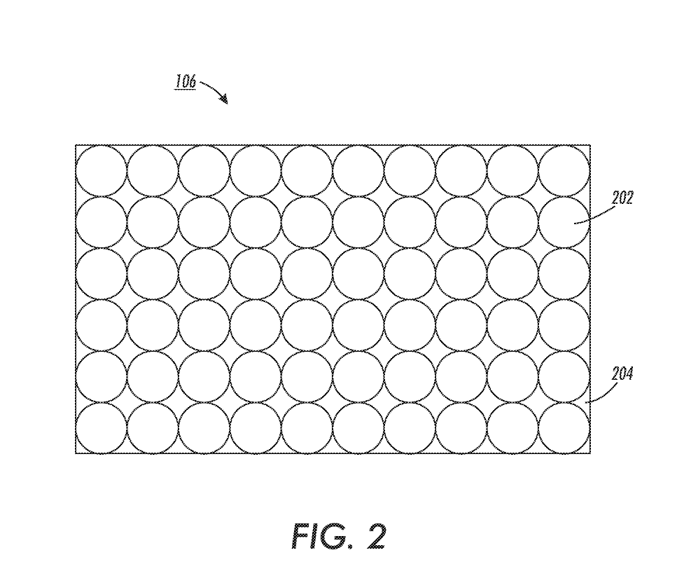

The inner layer 106 may be produced using multiple processes. FIG. 2 illustrates one such inner layer 106. Here, microcapsules 202 may be added to a polypropylene mass 204 which is injection-molded to form the final component. It will be understood that the number of microcapsules added to the polypropylene mass may vary. FIG. 2 illustrates closely spaced microcapsules 202. But, it will be understood that in other embodiments, the microcapsules 202 may be sparsely spaced or spaced in a different pattern without departing from the scope of the present invention.

A layer of melamine formaldehyde resin may enclose the microcapsules 202 so that they are completely airtight and mechanically sealed. The microcapsules 202 themselves include a porous, hardly deformable silicon dioxide core with absorbs the odiferous oils. The preferred dimensions of the microcapsules 202 may be in the range of a few micrometers to a few hundred micrometers. It will be understood, however, that the microcapsules of other dimensions may be utilized as well without departing from the scope of the present invention.

The thickness of the outer layer 104 can be adjusted based on certain criteria. For example, in organizations that cannot sustain any downtime, the outer layer thickness may be bare minimal. In this case, the inner layer 106 may be exposed in a shorter time frame, sometimes, even before the wearing causes any misfeeds. In other cases, where downtime is not of high concern, the outer layer 104 may be thicker.

Under external pressure, the microcapsules 202 open and exude the odoriferous substances just before the component fails. Detection by smell not only indicates when components need to be replaced, but also enables damage outside the safety range to be detected.

Odiferous oils are known in the art, and any of these oils or substances may be utilized to alert the user. For example, fruit or flower fragrances may be utilized. Alternatively, the system may utilize oils that give off a stink. In some embodiments, different odiferous oils may be utilized for different components, making it easy for a customer to determine which component has failed.

Currently, service centers rely on complex calculations of expected device life based on usage patterns to set up service contracts and service frequency. Subsequently, preventive maintenance service is scheduled at predetermined times to coincide with the expected life, and involves specific tasks to address wear. Behavior or usage, however, does not necessarily correspond to expectations. Moreover, certain customers may not have service contracts and may not have the benefit of periodic interventions to catch issues before they become visibly manifest.

Service centers rely on customers to identify certain symptoms over the phone indicating component failure. A service representative analysis these symptoms to diagnose the problem. The diagnosis is provided to a service engineer who visits the customer with appropriate spare parts. As stated previously, the service representative may hazard a wrong diagnosis, which leads the service engineer in carrying the wrong replacement parts to the customer's premises, increasing the device downtime.

With the inclusion of the odiferous oil layer, diagnosis may be confirmed even before the service engineer examines the imaging device. Representatives can confirm the diagnosis by simply asking the customer if the imaging device is diffusing a particular odor. For instance, in the case of the feed roller 100, when the outer layer 104 wears off, the customer may begin to experience intermittent problems with paper feeding. These problems may increase to a point where the user places a call to the service team. The service team then asks the caller whether the imaging device smells of strawberries (for example) to confirm whether the feed roller 100 is indeed the malfunctioning part. The response to this question provides a more focused and leaner service call from the engineer, potentially saving precious downtime and the associated costs.

Therefore, by creating a dual layer composite roller that has typical properties for the outer layer 104 and odiferous oil filled capsules for the inner layer 106, the roller, when worn, takes on the additional properties of giving off a particular smell. This feedback mechanism could be incorporated into the existing service strategy and service activities, by linking symptoms to causes via customer confirmation.

It will be understood that the embodiments of the present invention are not limited to just rollers in an imaging device. The odiferous oil capsule layer may be added to any component of the imaging device that might wear off due to continued use. For example, the odiferous oil layer may be added to baffles, assist rollers, flexible belts, or media passage paths, without departing from the scope of the present invention. Moreover, if multiple odiferous oil layers are implemented in a single imaging device, different distinct smells can be used for different parts. For example, one part might give off the smell of rotten eggs, while another part may smell of grapes. Customers may find it easy to distinguish between such varied smells and inform the customer service representative whether the smell is pleasant or not.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A component of an image forming device subjectable to surface wear, the component comprising:
an outer layer made of wearable material; and
an inner layer composed of multiple microcapsules filled with odiferous oils;
wherein wear of the outer layer exposes the inner layer, breaking the microcapsules, and releasing the odiferous oils.

2. The component of claim 1, wherein the outer layer is made of at least one of closed cell foam, elastomer, plastic, or rubber.

3. The component of claim 1, wherein the microcapsules are added to a polypropylene mass and injection molded to form the inner layer.

4. The component of claim 3, wherein the inner layer further comprises a layer of melamine formaldehyde resin for mechanically sealing the microcapsules.

5. The component of claim 1, wherein the microcapsules crack under pressure.

6. The component of claim 1, wherein the image forming device is at least one of a printer, scanner, or copier.

7. The component of claim 1, wherein the component is at least one of a roller, flexible belt, or baffle.

8. A wearable feed roller of an image forming device, the feed roller comprising:
a shaft;
an outer layer made of wearable material; and
an inner layer between the shaft and the outer layer, the inner layer made of multiple microcapsules filled with odiferous oils;
wherein wear of the outer layer exposes the inner layer, breaking the microcapsules, and releasing the odiferous oils.

9. The feed roller of claim 7, wherein the outer layer is made from at least one of elastomer, closed cell foam, plastic or rubber.

10. The feed roller of claim 7, wherein the microcapsules are added to a polypropylene mass and injection molded to form the inner layer.

11. The feed roller of claim 9, wherein the inner layer further comprises a layer of melamine formaldehyde resin for mechanically sealing the microcapsules.

12. The feed roller of claim 7, wherein the microcapsules crack under pressure.

13. The feed roller of claim 7, wherein the image forming device is at least one of a printer, scanner, or copier.
